(19) United States
(12) Patent Application Publication
(10) Pub. No.: US 2026/0006475 A1
(43) Pub. Date: Jan. 1, 2026

(54) METHOD, DEVICE AND COMPUTER STORAGE MEDIUM OF COMMUNICATION

(71) Applicant: NEC Corporation, Tokyo (JP)

(72) Inventors: Da WANG, Beijing (CN); Gang WANG, Beijing (CN)

(73) Assignee: NEC Corporation, Tokyo (JP)

(21) Appl. No.: 18/881,585

(22) PCT Filed: Jul. 11, 2022
(86) PCT No.: PCT/CN2022/105005

§ 371 Date: Jan. 6, 2025

(51) Int. Cl. H04W 24/10; H04L 43/091

(52) U.S. Cl. CPC H04W 24/10; H04L 43/091

(57) ABSTRACT

Embodiments of the present disclosure relate to a User Equipment (UE) and methods of communication for the UE and a network device. The UE receives, from a network device, a Radio Resource Control (RRC) reconfiguration message including first configuration information of an application layer measurement for a Quality of Experience (QoE) measurement. The first configuration information comprises second configuration information regarding the application layer measurement applicable to idle and inactive states.

### TECHNICAL FIELD

Embodiments of the present disclosure generally relate to the field of telecommunication, and in particular, to methods, devices and computer storage media of communication for an application layer measurement in idle and inactive states.

### BACKGROUND

An application layer measurement collection function enables collection of application layer measurements from a terminal device. Conventionally, the application layer measurement collection is supported in a connected state only. Currently, a new radio (NR) technology is to support a multicast and broadcast service (MBS) in idle and inactive states. As a MBS is an important service, it is also expected to enhance application layer measurements in idle and inactive states so as to well support the MBS in the idle and inactive states. However, a mechanism of an application layer measurement in idle and inactive states is still unclear and needs to be further developed.

### SUMMARY

In general, embodiments of the present disclosure provide methods, devices and computer storage media of communication for an application layer measurement in idle and inactive states.

In a first aspect, there is provided a method of communication. The method comprises: receiving, at a terminal device in a connected state, a configuration regarding an application layer measurement, the configuration comprising at least one of a set of measurement configurations, a set of values of timers or a set of validity areas; and in accordance with a determination that the terminal device enters an idle or inactive state, performing the application layer measurement based on the configuration.

In a second aspect, there is provided a method of communication. The method comprises: transmitting, at a network device, a configuration regarding an application layer measurement, the configuration comprising at least one of a set of measurement configurations, a set of values of timers or a set of validity areas.

In a third aspect, there is provided a device of communication. The device comprises a processor configured to cause the device to perform the method according to any of the first and second aspects of the present disclosure.

In a fourth aspect, there is provided a computer readable medium having instructions stored thereon. The instructions, when executed on at least one processor, cause the at least one processor to perform the method according to any of the first and second aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating a process of communication for an application layer measurement according to embodiments of the present disclosure;

FIG. 3 illustrates an example method of communication implemented at a terminal

device in accordance with some embodiments of the present disclosure;

FIG. 4 illustrates an example method of communication implemented at a network device in accordance with some embodiments of the present disclosure; and

FIG. 5 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IOT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHZ), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’

The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the term “application layer measurement” may be interchangeably used with “quality of experience (QoE) measurement”. The term “application layer measurement in idle and inactive states” may be interchangeably used with “a logged QoE measurement” or “a logged application layer measurement”. The term “a logged minimization of drive tests (MDT) measurement” may be interchangeably used with “a logged measurement”. The term “a MDT measurement in a connected state” may be interchangeably used with “an immediate MDT measurement”. The term “a MDT measurement in idle and inactive states” may be interchangeably used with “a logged MDT measurement”.

In the context of the present application, the term “upper layers” may refer to an application layer or any other layers having similar function as the application layer in the present application. The term “a lower layer” may refer to a radio resource control (RRC) layer or any other layers having similar function as the RRC layer in the present application.

Embodiments of the present disclosure provide a solution of an application layer measurement in idle and inactive states. In the solution, a network device transmits a configuration regarding an application layer measurement to a terminal device in a connected state. The configuration comprises at least one of a set of measurement configurations, a set of values of timers or a set of validity areas. When entering an idle or inactive state, the terminal device performs an application layer measurement based on the configuration.

In this way, an application layer measurement in idle and inactive states may be well supported.

Principles and implementations of the present disclosure will be described in detail below with reference to the figures.

### Example of Communication Network

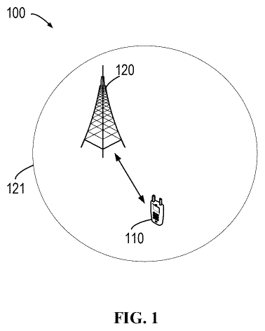

FIG. 1 illustrates a schematic diagram of an example communication network 100 in which some embodiments of the present disclosure can be implemented. As shown in FIG. 1, the communication network 100 may include a terminal device 110 and a network device 120. The network device 120 may provide a cell 121 to serve one or more terminal devices. In this example, the terminal device 110 is located in the cell 121 and is served by the network device 120.

It is to be understood that the number of devices and cells in FIG. 1 is given for the purpose of illustration without suggesting any limitations to the present disclosure. The communication network 100 may include any suitable number of network devices and/or terminal devices and/or cells adapted for implementing implementations of the present disclosure.

In some embodiments, the terminal device 110 and the network device 120 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, the network device 120 may provide a service such as a MBS to the terminal device 110. The terminal device 110 may perform an application layer measurement for the service, and report results of the application layer measurement to the network device 120.

In some embodiments, the terminal device 110 may perform a signaling based application layer measurement. In this case, an operation administration and maintenance (OAM) function (not shown) may initiate activation of an application layer measurement for a specific terminal device via a core network (CN) (not shown), and the network device 120 may receive one or more application layer measurement configurations by means of a terminal device-associated signaling. The application layer measurement configuration for signaling based activation may comprise an application layer measurement configuration list and the corresponding information for an application layer measurement collection, e.g., application layer measurement reference, service type, measurement collection entity (MCE) Internet protocol (IP) address, slice scope, area scope, minimization of drive tests (MDT) alignment information and an indication of available radio access network (RAN) visible QoE metrics.

In some embodiments, the terminal device 110 may perform a management based application layer measurement. In this case, the OAM function may send one or more application layer measurement configurations directly to the network device 120. An application layer measurement configuration for management based activation may also comprise an application layer measurement configuration list and the corresponding information for application layer measurement collection. Each application layer measurement configuration is encapsulated in a transparent container and is transmitted to the terminal device 110. The network device 120 may select terminal device(s) that meet the required application layer measurement capability; area scope and slice scope.

In some embodiments, radio-related measurements may be collected via immediate MDT for all types of supported services for the purpose of QoE analysis. The MCE/trace collection entity (TCE) performs correlation of immediate MDT results and application layer measurement results collected at the same terminal device. Alignment between a signaling based application layer measurement and a signaling based MDT measurement may be supported. In this case, the signaling based application layer measurement configuration sent to the network device 120 may comprise the NG-RAN Trace identity (ID) of a signaling based MDT measurement. Alignment between a management based application layer measurement and a management based MDT measurement may be supported.

In some embodiments, the terminal device 110 configured with application layer measurements may send an indication to inform the network device 120 about a start or stop of a session of configured application layer measurements. The network device 120 may activate MDT measurements that are to be aligned with the application layer measurements performed by the terminal device 110 upon/after receiving the session start indication from the terminal device 110. The network device 120 may activate MDT measurements upon/after receiving a MDT activation message from OAM. The network device 120 may deactivate aligned MDT measurements according to OAM command which may, e.g., be triggered by the session stop indication. The network device 120 may incorporate time stamp information into application layer measurement reports to enable correlation of corresponding measurement results of MDT and an application layer measurement at the MCE/TCE. In some embodiments, the network device 120 may incorporate MDT session identifiers (Trace Reference and Trace Recording Session Reference) into the corresponding application layer measurement report.

As mentioned above, a mechanism of an application layer measurement in idle and inactive states is still unclear. For example, it is unclear how to perform an application layer measurement in idle and inactive states. It is also unclear how to avoid overriding of a configuration of a signaling based logged application layer measurement. In addition, alignment between logged application layer measurement and logged MDT measurement is unclear.

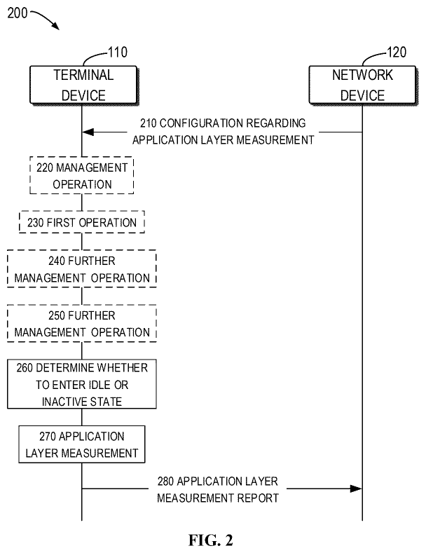

Embodiments of the present disclosure provide a solution of an application layer measurement in idle and inactive states so as to overcome the above and other potential issues. More details of the solution will be described with reference to FIG. 2.

### Example Implementation of Application Layer Measurement

FIG. 2 illustrates a schematic diagram illustrating a process 200 of communication for an application layer measurement according to embodiments of the present disclosure. For the purpose of discussion, the process 200 will be described with reference to FIG. 1. The process 200 may involve the terminal device 110 and the network device 120 as illustrated in FIG. 1.

### Configuration

As shown in FIG. 2, the network device 120 transmits 210 a configuration regarding an application layer measurement to the terminal device 110. In some embodiments, the configuration may be carried in a RRC message. For example, the RRC message may comprise a RRC reconfiguration message, a RRC release message, a logged measurement configuration message, or a message dedicated for transmission of the configuration.

In some embodiments, the configuration may comprise a set of measurement configurations. In some embodiments, the configuration may comprise one measurement configuration. In some embodiments, the configuration may comprise multiple measurement configurations.

In some embodiments, a measurement configuration in the set of measurement configurations may comprise an ID of the measurement configuration. In some embodiments, a measurement configuration may comprise a container of the application layer measurement for upper layers (e.g., an application layer). In some embodiments, a measurement configuration may comprise a service type indicating a subset of services in the connected state (e.g., a broadcast service).

In some embodiments, a measurement configuration may comprise a measurement configuration of a RAN visible application layer measurement. In some embodiments, the measurement configuration of the RAN visible application layer measurement may comprise at least one of the following: report periodicity; the maximum number of buffer level entries that can be reported for RAN visible application layer measurements; or an indication indicating whether the terminal device 110 shall report initial playout delay for RAN visible application layer measurements. It is to be understood that the measurement configuration of the RAN visible application layer measurement may comprise any combination of the above and other suitable information.

In some embodiments, the measurement configuration may comprise an indication indicating whether the terminal device 110 transmits a notification when a session in the application layer starts and stops.

In some embodiments, the measurement configuration may comprise an indication indicating whether the measurement configuration is logged or used for the terminal device 110 in the idle or inactive state. In other words, the measurement configuration may comprise an indication indicating whether the measurement configuration is not released or stored when entering the idle or inactive state.

In some embodiments, the measurement configuration may comprise an indication indicating whether the measurement configuration is used for a signaling based application layer measurement or a management based application layer measurement.

It is to be understood that the measurement configuration in the set of measurement configurations may comprise any combination of the above and other suitable information.

In some embodiments, the configuration regarding the application layer measurement may comprise a set of values of timers. In some embodiments, the configuration may comprise one value of timer. In some embodiments, the set of values of timers may comprise a value of a timer for a measurement configuration used for a signaling based application layer measurement. In some embodiments, the set of values of timers may comprise a value of a timer for a measurement configuration used for a management based application layer measurement. In some embodiments, the set of values of timers may comprise a value of a timer for a measurement configuration used for a RAN visible application layer measurement. In some embodiments, the set of values of timers may comprise a value of a timer for the set of measurement configurations. In some embodiments, the set of values of timers may comprise or a value of a timer for a configuration in the set of measurement configurations. It is to be understood that the set of values of timers may comprise any combination of the above and other suitable information.

In some embodiments, the configuration regarding the application layer measurement may comprise a set of validity areas. In some embodiments, the configuration may comprise one validity area. In some embodiments, the set of validity areas may comprise a validity area for a measurement configuration used for a signaling based application layer measurement. In some embodiments, the set of validity areas may comprise a validity area for a measurement configuration used for a management based application layer measurement. In some embodiments, the set of validity areas may comprise a validity area for a measurement configuration used for a RAN visible application layer measurement. In some embodiments, the set of validity areas may comprise a validity area for the set of measurement configurations. In some embodiments, the set of validity areas may comprise a validity area for a configuration in the set of measurement configurations. It is to be understood that the set of validity areas may comprise any combination of the above and other suitable information.

In some embodiments, each validity area may comprise a set of cell identities. In some embodiments, the validity area may comprise a set of tracking area codes. In some embodiments, the validity area may comprise a set of tracking area identities. In some embodiments, the validity area may comprise a set of RAN notification areas. In some embodiments, the validity area may comprise a set of frequencies. It is to be understood that the validity area may comprise any combination of the above and other suitable information.

It is also to be understood that the configuration regarding the application layer measurement may comprise any other suitable information or combination of information.

### UE Behavior Upon Reception of Configuration

The terminal device 110 receives, in a connected state, the configuration regarding the application layer measurement. With reference to FIG. 2, upon reception of the configuration, the lower layer (e.g., RRC layer) of the terminal device 110 may perform 220 a management operation associated with an application layer measurement. Some example embodiments will be described in connection with Embodiments 1 to 3 below.

### Embodiment 1

In some embodiments, the terminal device 110 may inform from a lower layer to upper layers to release at least a portion of a further configuration regarding a further application layer measurement. In the context of the present disclosure, the further configuration may refer to any previous or stored application layer measurement configuration, and the further application layer may refer to any application layer measurement based on the further configuration.

In some embodiments, the terminal device 110 may inform from the lower layer to the upper layers to release all previous or stored application layer measurement configurations. In some embodiments, the terminal device 110 may forward an ID of the received configuration regarding the application layer measurement to the upper layers and inform the upper layers to release a previous or stored configuration having the same ID. In some embodiments, the terminal device 110 may inform the upper layers to release a management based application layer measurement configuration by providing the ID of the management based application layer measurement configuration to the upper layers.

In some embodiments, the terminal device 110 may discard at least a portion of reports regarding the further application layer measurement. In some embodiments, the terminal device 110 may discard all reports of application layer measurements based on all previous or stored configurations. In some embodiments, the terminal device 110 may discard a report of an application layer measurement based on a previous or stored configuration having the same ID as an ID of the received configuration. In some embodiments, the terminal device 110 may inform from the lower layer to the upper layers to discard a report of an application layer measurement for a management based application layer measurement configuration.

In some embodiments where the received configuration comprises a configuration (for convenience, also referred to as a first configuration herein) regarding an application layer measurement in idle and inactive states (i.e., a logged application layer measurement), the terminal device 110 may forward, from the lower layer to the upper layers, the first configuration regarding a logged application layer measurement.

In some embodiments, the terminal device 110 may start or restart a timer. In some embodiments, the terminal device 110 may set the timer to have a same value as that provided in the received configuration. In some embodiments, the terminal device 110 may start or restart the timer when the terminal device 110 enters an idle or inactive state.

In some embodiments, upon receiving the configuration regarding the application layer measurement, the lower layer of the terminal device 110 may indicate the upper layers to suspend or deactivate or stop the application layer measurement. In some embodiments, upon entering an idle or inactive state, the terminal device 110 may indicate the upper layers to resume or activate or start the application layer measurement.

It is to be understood that the terminal device 110 may perform any combination of the above management operations and any other suitable management operations.

### Embodiment 2

In this embodiment, the received configuration may comprise the first configuration regarding a logged application layer measurement.

In some embodiments, the terminal device 110 may discard at least a portion of a previous or stored configuration (for convenience, also referred to as a second configuration herein) regarding a logged application layer measurement. In some embodiments, the terminal device 110 may discard all the previous or stored configurations regarding logged application layer measurements. In some embodiments, the terminal device 110 may discard a previous or stored configuration regarding a logged application layer measurement with the same ID as an ID of the first configuration. In some embodiments, the terminal device 110 may discard a previous or stored configuration for a management based logged application layer measurement.

In some embodiments, the terminal device 110 may discard at least a portion of reports regarding an application layer measurement (i.e., a logged application layer measurement) based on the second configuration. In some embodiments, the terminal device 110 may discard all reports regarding logged application layer measurements. In some embodiments, the terminal device 110 may discard a report of a logged application layer measurement for a configuration with the same ID as an ID of the first configuration. In some embodiments, the terminal device 110 may discard a report of a management based logged application layer measurement.

In some embodiments, the terminal device 110 may store parameters comprised in the first configuration. For example, the terminal device 110 may store the parameters in a variable of the terminal device 110. Of course, any other suitable ways are also feasible.

In some embodiments, the terminal device 110 may start or restart a timer. In some embodiments, the terminal device 110 may set the timer to have a same value as that provided in the first configuration. In some embodiments, the terminal device 110 may start or restart the timer when the terminal device 110 enters an idle or inactive state.

In some embodiments, upon entering an idle or inactive state, the lower layer of the terminal device 110 may forward the first configuration to the upper layers. In some embodiments, the terminal device 110 may discard the previous or stored configuration for a logged application layer measurement.

It is to be understood that the terminal device 110 may perform any combination of the above management operations and any other suitable management operations.

### Embodiment 3

In some embodiments, the terminal device 110 may inform from a lower layer to upper layers to release at least a portion of a further configuration regarding a further application layer measurement. In the context of the present disclosure, the further configuration may refer to any previous or stored application layer measurement configuration, and the further application layer may refer to any application layer measurement based on the further configuration.

In some embodiments, the terminal device 110 may inform from the lower layer to the upper layers to release all previous or stored application layer measurement configurations. In some embodiments, the terminal device 110 may forward an ID of the received configuration regarding the application layer measurement to the upper layers and inform the upper layers to release a previous or stored configuration having the same ID. In some embodiments, the terminal device 110 may inform the upper layers to release a management based application layer measurement configuration by providing the ID of the management based application layer measurement configuration to the upper layers.

In some embodiments, the terminal device 110 may discard at least a portion of reports regarding the further application layer measurement. In some embodiments, the terminal device 110 may discard all reports of application layer measurements based on all previous or stored configurations. In some embodiments, the terminal device 110 may discard a report of an application layer measurement based on a previous or stored configuration having the same ID as an ID of the received configuration. In some embodiments, the terminal device 110 may inform from the lower layer to the upper layers to discard a report of an application layer measurement for a management based application layer measurement configuration.

In some embodiments where the received configuration comprises the first configuration regarding a logged application layer measurement, the terminal device 110 may forward, from the lower layer to the upper layers, the first configuration regarding a logged application layer measurement.

In some embodiments, the terminal device 110 may start or restart a timer. In some embodiments, the terminal device 110 may set the timer to have a same value as that provided in the received configuration. In some embodiments, the terminal device 110 may start or restart the timer when the terminal device 110 enters an idle or inactive state.

In some embodiments, if a measurement configuration in the set of measurement configurations is indicated to be not applied for the idle or inactive state, the terminal device may release the measurement configuration upon entering the idle state. In some embodiments, if a measurement configuration in the set of measurement configurations is indicated to be not applied for the idle or inactive state, the terminal device may store the measurement configuration upon entering the inactive state. In some embodiments, if a measurement configuration in the set of measurement configurations is indicated to be applied for the idle or inactive state, using, upon entering the idle or inactive state, the measurement configuration to perform the application layer measurement.

For example, when the terminal device 110 enters the idle or inactive state, the terminal device 110 may determine whether the network device 120 indicates that the received configuration is applied for idle or inactive state. If the network device 120 indicates that the received configuration is not applied for idle or inactive state, the terminal device may release the measurement configuration upon entering the idle state or store the measurement configuration in UE access stratus (AS) context upon entering the inactive state. If the network device 120 indicates that the received configuration is applied for idle or inactive state, the terminal device may continue to use the measurement configuration in the idle or inactive state.

It is to be understood that the terminal device 110 may perform any combination of the above management operations and any other suitable management operations.

Embodiments 1 to 3 may be used separately or in any suitable combination. In some cases, an application layer of a UE may not be aware of the RRC state of the UE, but the broadcast service may happen at all UE states. According to the present solution, the application layer may not need to perform a logged application layer measurement when the UE is in a connected state.

### UE Behavior upon Expiration of Timer

Continue to refer to FIG. 2, if a timer described above expires, the lower layer of terminal device 110 may perform 230 a further management operation (for convenience, also referred to as a first operation herein) associated with an application layer measurement. In some embodiments, the timer may be a timer for a measurement configuration used for all application layer measurements. In some embodiments, the timer may be a timer for a measurement configuration used for a signaling based application layer measurement. In some embodiments, the timer may be a timer for a measurement configuration used for a management based application layer measurement. In some embodiments, the timer may be a timer for a measurement configuration used for a RAN visible application layer measurement. In some embodiments, the timer may be a timer for a set of measurement configurations. In some embodiments, the timer may be a timer for a measurement configuration in a set of measurement configurations.

In some embodiments where a timer for a measurement configuration expires, the terminal device 110 may discard the measurement configuration. In some embodiments where a timer for a measurement configuration expires, the terminal device 110 may discard a RAN visible application layer measurement configuration in the measurement configuration.

In some embodiments where a timer for a measurement configuration expires, the terminal device 110 may inform the upper layer to release the measurement configuration or suspend an application layer measurement based on the measurement configuration. In some embodiments where a timer for a measurement configuration expires, the terminal device 110 may inform the upper layer to release a RAN visible application layer measurement configuration in the measurement configuration or suspend a RAN visible application layer measurement based on the RAN visible application layer measurement configuration.

In some embodiments where a timer for a measurement configuration expires, the terminal device 110 may discard a report of an application layer measurement based on the measurement configuration after a period of time (for convenience, also referred to as a first period of time herein) since the timer expires. For example, the first period of time may be 48 hours or any suitable values. In some embodiments where a timer for a measurement configuration expires, the terminal device 110 may discard a report of a RAN visible application layer measurement based on the measurement configuration after a period of time (for convenience, also referred to as a second period of time herein) since the timer expires. For example, the second period of time may be 48 hours or any suitable values.

In this way, UE may remain at an idle or inactive state for a very long time, and there is no need to perform application layer measurement all the time. By using a timer, a maximum validly time of the application layer measurement may be supported.

### UE Behavior upon Move Out of Validity Area

Continue to refer to FIG. 2, if the terminal device 110 moves from a cell (for convenience, also referred to as a first cell herein) that belongs to a validity area to a cell (for convenience, also referred to as a second cell herein) that does not belong to the validity area, the lower layer of terminal device 110 may perform 240 a further management operation associated with an application layer measurement. In some embodiments, the validity area may be a validity area for a measurement configuration used for all application layer measurements. In some embodiments, the validity area may be a validity area for a measurement configuration used for a signaling based application layer measurement. In some embodiments, the validity area may be a validity area for a measurement configuration used for a management based application layer measurement. In some embodiments, the validity area may be a validity area for a measurement configuration used for a RAN visible application layer measurement. In some embodiments, the validity area may be a validity area for a set of measurement configurations. In some embodiments, the validity area may be a validity area for a configuration in a set of measurement configurations.

In some embodiments where the terminal device 110 moves from the first cell to the second cell, the lower layer of terminal device 110 may inform upper layers of the terminal device 110 to release a measurement configuration associated with the validity area or suspend/deactivate/stop an application layer measurement based on the measurement configuration. In some embodiments where the terminal device 110 moves from the first cell to the second cell, the terminal device 110 may inform upper layers of the terminal device 110 to release a RAN visible application layer measurement configuration in a measurement configuration associated with the validity area or suspend/deactivate/stop a RAN visible application layer measurement based on the RAN visible application layer measurement configuration.

In some embodiments where the terminal device 110 moves from the first cell to the second cell, the terminal device 110 may discard a measurement configuration associated with the validity area. In some embodiments where the terminal device 110 moves from the first cell to the second cell, the terminal device 110 may discard a RAN visible application layer measurement configuration in a measurement configuration associated with the validity area.

In some cases, an application layer measurement report may not be needed for some network. With the present solution, there is no need to perform an application layer measurement when UE is outside a validity area in which a network may want an application layer measurement report.

### UE Behavior upon Move Back to Validity Area

Continue to refer to FIG. 2, if the terminal device 110 moves from the second cell that does not belong to the validity area to a first cell that belongs to the validity area, the lower layer of the terminal device 110 may perform 250 a further management operation associated with an application layer measurement.

In some embodiments, the terminal device 110 may inform the upper layers to resume or activate or start an application layer measurement based on a measurement configuration associated with the validity area. In some embodiments, the terminal device 110 may inform the upper layers to resume or activate or start a RAN visible application layer measurement based on a measurement configuration associated with the validity area. In some embodiments, the terminal device 110 may forward, to the upper layers, a stored measurement configuration associated with the validity area. In some embodiments, the terminal device 110 may forward, to the upper layers, a RAN visible application layer measurement configuration in a stored measurement configuration associated with the validity area.

In this way, there is only need to perform an application layer measurement when UE is in a validity area in which a network may want an application layer measurement report.

### Application Layer Measurement Reporting

Continue to refer to FIG. 2, the terminal device 110 determines 260 whether to enter an idle or inactive state. If the terminal device 110 enters the idle or inactive state, the terminal device 110 performs 270 an application layer measurement based on the configuration. The application layer measurement may be performed in any suitable ways and the present application does not limit this aspect. Then the lower layer (e.g., RRC layer) of terminal device 110 transmits 280 a report of the application layer measurement (i.e., results of the application layer measurement) to the network device 120. Some example embodiments will be described in connection with Embodiments 4 to 5 below.

### Embodiment 4

In some embodiments, the terminal device 110 may store the report of the application layer measurement. For example, the terminal device 110 may store the report of the application layer measurement in a variable of the terminal device 110. It is to be understood that any other suitable ways are also feasible. In some embodiments, if a memory reserved for the application layer measurement becomes full, the terminal device 110 may stop a timer associated with the application layer measurement and perform similar operations as that performed upon expiration of the timer (i.e., the first operation as described above).

In some embodiments where there is a stored report of a logged application layer measurement, the terminal device 110 may cause a list of identities or a bitmap to be comprised in the report of the application layer measurement. The list of identities or the bitmap may indicate that at least one measurement configuration has available measurement results. For example, the terminal device 110 may cause the list of identities or the bitmap to be comprised in a RRCSetupComplete or RRCResumeComplete or RRCReconfigurationComplete or RRCRestablishmentComplete message. It is to be understood that any other suitable ways are also feasible.

In some embodiments, the network device 120 may transmit a list of identities or a bitmap indicating that measurement results associated with at least one measurement configuration is to be reported. Upon reception of the list of identities or the bitmap, the terminal device 110 may report the measurement results associated with the at least one measurement configuration. In some embodiments, the terminal device 110 may report the measurement results in a UEInformationResponse message. In some embodiments, the terminal device 110 may discard the stored report (e.g., the stored measurement results).

In this way, a logged application layer measurement may be stored and reported

when UE enters a connected state.

### Embodiment 5

In some embodiments, the terminal device 110 may initiate a RRC setup procedure or a RRC resume procedure for transmission of a report of the application layer measurement. In some embodiments, the terminal device 110 may set an establishment cause or resume cause as “mo-signaling”. In some embodiments, a RRC layer of the terminal device 110 may set an establishment cause or resume cause as a new value, for example a value indicating QoE report or radio access layer signaling. In some embodiments, the RRC layer of the terminal device 110 may need to provide parameters for unified access control for the RRC setup or RRC resume procedure. In some embodiments, the parameters for unified access control may comprise access category and access identity.

In some embodiments, the terminal device 110 may transmit a report of the application layer measurement in a RRC message. In some embodiments, the terminal device 110 may set contents of a RRC message based on the logged application layer measurement report received from upper layers. In some embodiments, the RRC message may be MeasurementReportAppLayer message or any other suitable messages, and submit the RRC message to lower layers for transmission.

In some embodiments, the terminal device 110 may transmit the report of the application layer measurement via a small data transmission (SDT). In some embodiments, the terminal device 110 may transmit, via a signaling radio bearer (SRB), a RRC message carrying the report of the application layer measurement. In some embodiments, the SRB may comprise a SRB2. In some embodiments where the network device 120 may configure SRB1 for SDT, the SRB may comprise the SRB1 configured for SDT. In some embodiments where the network device 120 may configure SRB4 for SDT, the SRB may comprise the SRB4 configured for SDT. In some embodiments where the network device 120 may configure a dedicated SRB for SDT, the SRB may comprise the dedicated SRB.

In some embodiments, the terminal device 110 may transmit, in a RRC message to the network device 120, an indication indicating availability of a report of the application layer measurement. The network device 120 may transmit a request for obtaining the report of the application layer measurement to the terminal device 110. Upon reception of the request, the terminal device 110 may transmit the report of the application layer measurement to the network device 120.

For example, when setting contents of RRCResumeComplete or RRCSetupComplete message, if there is logged application layer measurement report to report, the terminal device 110 may add availability indication. The network device 120 may request for the logged application layer measurement report by sending a UEInformationRequest message with an request indication. Then the terminal device 110 may provide the logged application layer measurement report in a UEInformationResponse message, and discard the stored report.

In this way, a logged application layer measurement may be reported to a network immediately for the network to improve service quality.

### Content of Reporting

In some embodiments, the report may comprise an ID of a measurement configuration of the application layer measurement. In some embodiments, the report may comprise a container of the application layer measurement for upper layers. In some embodiments, the report may comprise an indication indicating whether a session is started or stopped.

In some embodiments, the report may comprise measurement results of a RAN visible application layer measurement. In some embodiments, the measurement results of the RAN visible application layer measurement may comprise at least one of the following: application layer buffer level, initial playout delay, a protocol data unit (PDU) session ID list, or MBS session information. For example, the MBS session information may comprise a temporary mobile group identity (TMGI) list or any other suitable information.

In some embodiments, the report may comprise information of a time stamp of the report. In some embodiments, the report may comprise information of an area at which the report is received by a lower layer from upper layers of the terminal device 110. In some embodiments, the information of the area may comprise at least one of the following: an ID of a cell; an ID of a tracking area; a tracking area code; an ID of a RAN notification area; or a frequency. It is to be understood that any other suitable information is also feasible.

In this way, when a network receives a logged application layer measurement report from a terminal device, the network may forward the information of the logged application layer measurement report to a further network device based on the area information received from the terminal device. The information of the logged application layer measurement report may include at least RAN visible application layer measurement results.

### UE Behavior Upon Entering Connected State

In some embodiments, the terminal device 110 may change from the idle or inactive state to the connected state. In these embodiments, the lower layer of the terminal device 110 may inform the upper layers to release the received configuration regarding the application layer measurement or suspend or deactivate or stop the application layer measurement.

In this way, a terminal device may stop an application layer measurement when the terminal device enters a connected state.

### Signaling Based Logged Application Layer Measurement Overridden Protection

A signaling based logged application layer measurement is more important than a management based logged application layer measurement. However, a signaling based logged application layer measurement configuration may be overridden by a management based logged application layer measurement configuration. The unwanted overriding may happen for the following cases: 1) a signaling based logged application layer measurement is configured, but no results are available, e.g., so far nothing is stored, or all previously stored results are retrieved; 2) a signaling based logged application layer measurement configuration is stopped (i.e. the expiry of timer), but a terminal device still has un-retrieved results that may be discarded upon reception of a new configuration.

Embodiments of the present disclosure provide solutions to overcome the above issue. These solutions are described in connection with Embodiments 6 to 7.

### Embodiment 6

In this embodiment, a measurement configuration in the set of measurement configurations may comprise an indication indicating whether the measurement configuration is used for a signaling based application layer measurement.

In some embodiments, if a timer described above is running, the terminal device 110 may transmit, to the network device 120, a RRC message comprising an indication indicating that the signaling based application layer measurement is available. If the timer is not running and measurement results of the application layer measurement is to be reported, the terminal device 110 may transmit, to the network device 120, a RRC message comprising an indication indicating that the signaling based application layer measurement is unavailable. In some embodiments, the RRC message may be RRCSetupComplete, RRCResumeComplete, RRCResumeComplete1, RRCReestablishmentComplete or

RRCReconfigurationComplete messages. It is to be understood that any other suitable RRC messages are also feasible.

In this way, a signaling based logged application layer measurement configuration may not be overridden when a terminal device enters a connected state.

### Embodiment 7

In this embodiment, a measurement configuration in the set of measurement configurations may comprise an indication indicating whether the measurement configuration is used for a signaling based application layer measurement.

In some embodiments, if a timer described above is running, the terminal device 110 may transmit, to the network device 120, a RRC message comprising information of a measurement configuration associated with a signaling based application layer measurement that is available. In some embodiments, the information of a measurement configuration associated with a signaling based application layer measurement that is available may be a list ID of the measurement configuration associated with signalling based application layer measurement that are available, or a bitmap indicating the availability of the signalling based application layer measurement configuration. If the timer is not running and measurement results of the application layer measurement is to be reported, the terminal device 110 may transmit, to the network device 120, a RRC message comprising information of a measurement configuration associated with a signaling based application layer measurement that is unavailable. In some embodiments, the information of a measurement configuration associated with a signaling based application layer measurement that is unavailable may be a list ID of the measurement configuration associated with signalling based application layer measurement that unavailable, or a bitmap indicating the unavailability of the signalling based application layer measurement configuration. In some embodiments, the RRC message may be RRCSetupComplete, RRCResumeComplete, RRCResumeComplete1, RRCReestablishmentComplete or RRCReconfigurationComplete messages. It is to be understood that any other suitable RRC messages are also feasible.

In some embodiments, based on reception of the configuration regarding the application layer measurement, the terminal device 110 may release a measurement configuration having the same ID as a measurement configuration in the received configuration. Alternatively, the terminal device may release a management based application layer measurement.

In this way, a signaling based logged application layer measurement configuration may also not be overridden when a terminal device enters a connected state.

### Alignment of Logged MDT and Logged Application Layer Measurement

When an application layer session starts or stops, it is possible that logging for MDT is not started or stopped. To help a network to have combined radio related measurements and application layer measurement results, it is better that they should be aligned on the start or stop time point. Currently, how to support the alignment for an idle or inactive state UE is not clear.

Embodiments of the present disclosure provide solutions to support the alignment for an idle or inactive state UE. The alignment includes alignment between a signaling based logged application layer measurement and a signaling based logged MDT measurement, and alignment between a management based logged application layer measurement and a management based logged MDT measurement.

In some embodiments, the network device 120 may transmit, to the terminal device 110, an indication indicating whether alignment between a logged MDT measurement and the application layer measurement is supported. For example, the need of alignment may be configured as a new report type for a logged MDT.

In some embodiments, the network device 120 may transmit, to the terminal device 110, information of a measurement configuration for which a start or stop of a session triggers a start or stop of the logged MDT measurement. For example, the information of the measurement configuration may comprise an ID of the measurement configuration or any other suitable information.

In some embodiments, the network device 120 may transmit, to the terminal device 110, a trace reference of the logged MDT measurement for which the alignment is applied.

In some embodiments, if a session starts, the terminal device 110 may start performing the logged MDT measurement in a time interval. For example, when a RRC layer of the terminal device 110 receives session start information from upper layers of the terminal device 110, the RRC layer may start performing the logging of MDT at regular terminal intervals.

In some embodiments, if a session stops, the terminal device 110 may stop performing the logged MDT measurement. For example, when a RRC layer of the terminal device 110 receives session stop information from upper layers of the terminal device 110, the RRC layer may stop performing the logging of MDT.

In some embodiments, the terminal device 110 may cause time stamp information to be comprised in a logged application layer measurement report to enable correlation of corresponding measurement results of MDT and application layer measurements.

In this way, the start or stop application layer measurement and radio measurement in an idle or inactive state may be supported under network control.

So far, a mechanism of an application layer measurement in idle and inactive states may be provided. It is to be understood that the above embodiments may be used separately or in any suitable combination.

### Example Implementation of Methods

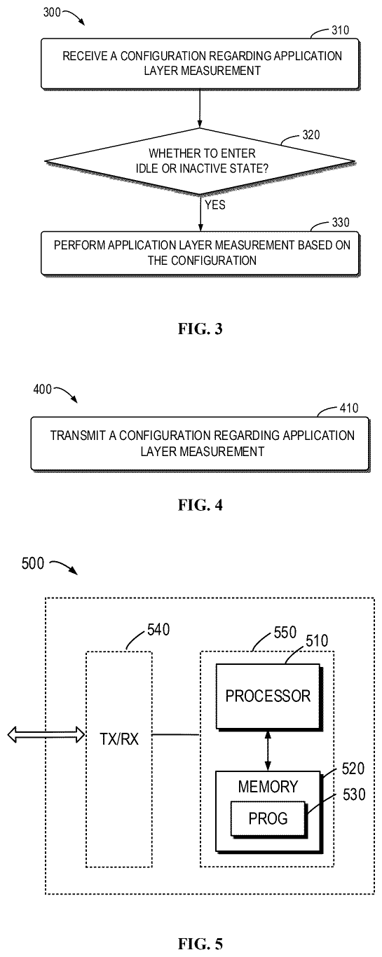

Accordingly, embodiments of the present disclosure provide methods of communication implemented at a terminal device and a network device. These methods will be described below with reference to FIGS. 3 and 4.

FIG. 3 illustrates an example method 300 of communication implemented at a terminal device in accordance with some embodiments of the present disclosure. For example, the method 300 may be performed at the terminal device 110 as shown in FIG. 1. For the purpose of discussion, in the following, the method 300 will be described with reference to FIG. 1. It is to be understood that the method 300 may include additional blocks not shown and/or may omit some blocks as shown, and the scope of the present disclosure is not limited in this regard.

At block 310, the terminal device 110 receives, in a connected state, a configuration regarding an application layer measurement. The configuration comprises at least one of a set of measurement configurations, a set of values of timers or a set of validity areas.

At block 320, the terminal device 110 determines the terminal device 110 enters an idle or inactive state. If the terminal device 110 enters the idle or inactive state, the method 300 proceeds to block 330.

At block 330, the terminal device 110 performs the application layer measurement based on the configuration.

In some embodiments, a measurement configuration in the set of measurement configurations may comprise at least one of the following: an identity of the measurement configuration; a container of the application layer measurement for an application layer; a service type indicating a subset of services in the connected state; a measurement configuration of a radio access network visible application layer measurement; an indication indicating whether the terminal device transmits a notification when a session in the application layer starts and stops; an indication indicating whether the measurement configuration is used for the terminal device in the idle or inactive state; or an indication indicating whether the measurement configuration is used for a signaling based application layer measurement or a management based application layer measurement.

In some embodiments, the set of values of timers may comprise at least one of the following: a value of a timer for a measurement configuration used for a signaling based application layer measurement; a value of a timer for a measurement configuration used for a management based application layer measurement; a value of a timer for a measurement configuration used for a radio access network visible application layer measurement; a value of a timer for the set of measurement configurations; or a value of a timer for a configuration in the set of measurement configurations.

In some embodiments, the set of validity areas may comprise at least one of the following: a validity area for a measurement configuration used for a signaling based application layer measurement; a validity area for a measurement configuration used for a management based application layer measurement; a validity area for a measurement configuration used for a radio access network visible application layer measurement; a validity area for the set of measurement configurations; or a validity area for a configuration in the set of measurement configurations.

In some embodiments, the set of validity areas may comprise at least one of the following: a set of cell identities; a set of tracking area codes; a set of tracking area identities; a set of radio access network notification areas; or a set of frequencies.

In some embodiments, if the configuration regarding the application layer measurement is received, the terminal device 110 may perform at least one of the following: informing upper layers of the terminal device to release at least a portion of a further configuration regarding a further application layer measurement; discarding at least a portion of reports regarding the further application layer measurement; forwarding, to the upper layers, a first configuration regarding an application layer measurement in idle and inactive states; starting or restarting a timer; starting or restarting a timer upon entering the idle or inactive state; indicating the upper layers to suspend or deactivate or stop the application layer measurement; or indicating the upper layers to resume or activate or start the application layer measurement upon entering the idle or inactive state.

In some embodiments, the configuration regarding the application layer measurement comprises a first configuration regarding an application layer measurement in idle and inactive states. In these embodiments, if the first configuration is received, the terminal device 110 may perform at least one of the following: discarding at least a portion of a second configuration regarding an application layer measurement in idle and inactive states; discarding at least a portion of reports regarding an application layer measurement based on the second configuration; storing parameters comprised in the first configuration; starting or restarting a timer; starting or restarting a timer upon entering the idle or inactive state; or forwarding the first configuration to the upper layers upon entering an idle or inactive state.

In some embodiments, if the configuration regarding the application layer measurement is received, the terminal device 110 may perform at least one of the following: informing an upper layers of the terminal device to release at least a portion of a further configuration regarding a further application layer measurement; discarding at least a portion of reports regarding the further application layer measurement; forwarding, to the upper layers, the configuration regarding the application layer measurement; starting or restarting a timer; starting or restarting a timer upon entering the idle or inactive state; or in accordance with a determination that a measurement configuration in the set of measurement configurations is indicated to be not applied for the idle or inactive state, releasing the measurement configuration upon entering the idle state or storing the measurement configuration upon entering the inactive state.

In some embodiments, if the timer expires, the terminal device 110 may perform a first operation. In some embodiments, if a memory reserved for the application layer measurement becomes full, the terminal device 110 may stop the timer and perform the first operation. The first operation may comprise at least one of the following: discarding the configuration regarding the application layer measurement; discarding a measurement configuration of a radio access network visible application layer measurement in the configuration regarding the application layer measurement; informing the upper layers to release the configuration regarding the application layer measurement or suspend the application layer measurement; informing the upper layers to release the measurement configuration of the radio access network visible application layer measurement or suspend the radio access network visible application layer measurement; discarding a report of the application layer measurement after a first period of time since the timer expires; or discarding a report of the radio access network visible application layer measurement after a second period of time since the timer expires.

In some embodiments, if the terminal device 110 moves from a first cell that belongs to a validity area to a second cell that does not belong to the validity area, the terminal device 110 may perform at least one of the following: informing upper layers of the terminal device to release the configuration regarding the application layer measurement or suspend the application layer measurement; informing upper layers of the terminal device to release a measurement configuration of a radio access network visible application layer measurement in the configuration regarding the application layer measurement or suspend the radio access network visible application layer measurement;

discarding the configuration regarding the application layer measurement; or discarding the measurement configuration of the radio access network visible application layer measurement.

In some embodiments, if the terminal device 110 moves from a second cell that does not belong to a validity area to a first cell that belongs to the validity area, the terminal device 110 may perform at least one of the following: informing upper layers of the terminal device to resume or activate or start the application layer measurement; informing the upper layers to resume or activate or start a radio access network visible application layer measurement; forwarding, to the upper layers, the configuration regarding the application layer measurement; or forwarding, to the upper layers, a measurement configuration of a radio access network visible application layer measurement in the configuration regarding the application layer measurement.

In some embodiments, the terminal device 110 may store a report of the application layer measurement. In some embodiments, the terminal device 110 may transmit a report of the application layer measurement, the report comprises a list of identities or a bitmap indicating that at least one measurement configuration has available measurement results. In some embodiments, based on reception of a list of identities or a bitmap indicating that measurement results associated with at least one measurement configuration is to be reported, the terminal device 110 may report the measurement results associated with the at least one measurement configuration.

In some embodiments, the terminal device 110 may initiate a radio resource control setup procedure or a radio resource control resume procedure for transmission of a report of the application layer measurement. In some embodiments, the terminal device 110 may transmit a report of the application layer measurement in a radio resource control message.

In some embodiments, the terminal device 110 may transmit the report of the application layer measurement via a small data transmission. In some embodiments, the terminal device 110 may transmit, via a signaling radio bearer, a radio resource control message carrying the report of the application layer measurement, the signaling radio bearer comprising at least one of the following: a signaling radio bearer 2; a signaling radio bearer 1 configured for the small data transmission; a signaling radio bearer 4 configured for the small data transmission; or a signaling radio bearer dedicated for the small data transmission.

In some embodiments, the terminal device 110 may transmit, in the radio resource control message, an indication indicating availability of the report of the application layer measurement; receive a request for obtaining the report of the application layer measurement; and transmit the report of the application layer measurement.

In some embodiments, the report may comprise at least one of the following: an identity of a measurement configuration of the application layer measurement; a container of the application layer measurement for upper layers; an indication indicating whether a session is started or stopped; measurement results of a radio access network visible application layer measurement; information of a time stamp of the report; or information of an area at which the report is received by a lower layer from upper layers of the terminal device.

In some embodiments, the measurement results of the radio access network visible application layer measurement may comprise at least one of the following: an application layer buffer level; an initial playout delay; a list of identities of protocol data unit sessions; or information of a multicast broadcast service session.

In some embodiments, the information of the area may comprise at least one of the following: an identity of a cell; an identity of a tracking area; a tracking area code; an identity of a radio access network notification area; or a frequency.

In some embodiments, if the terminal device 110 changes from the idle or inactive state to the connected state, the terminal device 110 may inform upper layers of the terminal device to release the configuration regarding the application layer measurement or suspend the application layer measurement.

In some embodiments, a measurement configuration in the set of measurement configurations comprises an indication indicating whether the measurement configuration is used for a signaling based application layer measurement. In these embodiments, if the timer is running, the terminal device 110 may transmit a radio resource control message comprising an indication indicating that the signaling based application layer measurement is available. In some embodiments, if the timer is not running and measurement results of the application layer measurement is to be reported, the terminal device 110 may transmit a radio resource control message comprising an indication indicating that the signaling based application layer measurement is unavailable.

Alternatively, if the timer is running, the terminal device 110 may transmit a radio

resource control message comprising information of a measurement configuration associated with a signaling based application layer measurement that is available. If the timer is not running and measurement results of the application layer measurement is to be reported, the terminal device 110 may transmit a radio resource control message comprising information of a measurement configuration associated with a signaling based application layer measurement that is unavailable. In some embodiments, based on reception of the configuration regarding the application layer measurement, the terminal device 110 may release a measurement configuration having a same identity as a measurement configuration in the configuration or releasing a management based application layer measurement.

In some embodiments, the terminal device 110 may receive an indication indicating whether alignment between a logged minimization of drive tests measurement and the application layer measurement is supported. In some embodiments, the terminal device 110 may receive information of a measurement configuration for which a start or stop of a session triggers a start or stop of the logged minimization of drive tests measurement. In some embodiments, the terminal device 110 may receive a trace reference of the logged minimization of drive tests measurement for which the alignment is applied.

In some embodiments, if a session starts, the terminal device 110 may start performing the logged minimization of drive tests measurement in a time interval. In some embodiments, if a session stops, the terminal device 110 may stop performing the logged minimization of drive tests measurement.

FIG. 4 illustrates an example method 400 of communication implemented at a network device in accordance with some embodiments of the present disclosure. For example, the method 400 may be performed at the network device 120 as shown in FIG. 1. For the purpose of discussion, in the following, the method 400 will be described with reference to FIG. 1. It is to be understood that the method 400 may include additional blocks not shown and/or may omit some blocks as shown, and the scope of the present disclosure is not limited in this regard.

At block 410, the network device 120 transmits a configuration regarding an application layer measurement. The configuration comprises at least one of a set of measurement configurations, a set of values of timers or a set of validity areas.

In some embodiments, a measurement configuration in the set of measurement configurations may comprise at least one of the following: an identity of the measurement configuration; a container of the application layer measurement for an application layer; a service type indicating a subset of services in the connected state; a measurement configuration of a radio access network visible application layer measurement; an indication indicating whether the terminal device transmits a notification when a session in the application layer starts and stops; an indication indicating whether the measurement configuration is used for a terminal device in an idle or inactive state; or an indication indicating whether the measurement configuration is used for a signaling based application layer measurement or a management based application layer measurement.

In some embodiments, the set of values of timers may comprise at least one of the following: a value of a timer for a measurement configuration used for a signaling based application layer measurement; a value of a timer for a measurement configuration used for a management based application layer measurement; a value of a timer for a measurement configuration used for a radio access network visible application layer measurement; a value of a timer for the set of measurement configurations; or a value of a timer for a configuration in the set of measurement configurations.

In some embodiments, the set of validity areas may comprise at least one of the following: a validity area for a measurement configuration used for a signaling based application layer measurement; a validity area for a measurement configuration used for a management based application layer measurement; a validity area for a measurement configuration used for a radio access network visible application layer measurement; a validity area for the set of measurement configurations; or a validity area for a configuration in the set of measurement configurations.

In some embodiments, the set of validity areas may comprise at least one of the following: a set of cell identities; a set of tracking area codes; a set of tracking area identities; a set of radio access network notification areas; or a set of frequencies.

In some embodiments, the network device 120 may receive a report of the application layer measurement, the report comprising a list of identities or a bitmap indicating that at least one measurement configuration has available measurement results. In some embodiments, the network device 120 may transmit a list of identities or a bitmap indicating that measurement results associated with at least one measurement configuration is to be reported.

In some embodiments, the network device 120 may perform a radio resource control setup procedure or a radio resource control resume procedure for reception of a report of the application layer measurement. In some embodiments, the network device 120 may receive a report of the application layer measurement in a radio resource control message. In some embodiments, the network device 120 may receive the report of the application layer measurement via a small data transmission.

In some embodiments, the network device 120 may configure a signaling radio bearer 1 for the small data transmission. In some embodiments, the network device 120 may configure a signaling radio bearer 4 for the small data transmission. In some embodiments, the network device 120 may configure a signaling radio bearer dedicated for the small data transmission. In some embodiments, the network device 120 may receive, via a signaling radio bearer, a radio resource control message carrying the report of the application layer measurement, the signaling radio bearer comprising at least one of the following: a signaling radio bearer 2; a signaling radio bearer 1 configured for the small data transmission; a signaling radio bearer 4 configured for the small data transmission; or a signaling radio bearer dedicated for the small data transmission.

In some embodiments, the network device 120 may receive, in the radio resource control message, an indication indicating availability of the report of the application layer measurement. The network device 120 may transmit a request for obtaining the report of the application layer measurement, and receive the report of the application layer measurement.

In some embodiments, the report may comprise at least one of the following: an identity of a measurement configuration of the application layer measurement; a container of the application layer measurement for upper layers; an indication indicating whether a session is started or stopped; measurement results of a radio access network visible application layer measurement; information of a time stamp of the report; or information of an area at which the report is received by a lower layer from upper layers of the terminal device.

In some embodiments, the information of the time stamp of the report may comprise at least one of the following: an application layer buffer level; an initial playout delay; a list of identities of protocol data unit sessions; or information of a multicast broadcast service session.

In some embodiments, the information of the area may comprise at least one of the following: an identity of a cell; an identity of a tracking area; a tracking area code; an identity of a radio access network notification area; or a frequency.

In some embodiments, the network device 120 may receive a radio resource control message comprising an indication indicating that the signaling based application layer measurement is available. In some embodiments, the network device 120 may receive a radio resource control message comprising an indication indicating that the signaling based application layer measurement is unavailable.

In some embodiments, the network device 120 may receive a radio resource control message comprising information of a measurement configuration associated with a signaling based application layer measurement that is available. In some embodiments, the network device 120 may receive a radio resource control message comprising information of a measurement configuration associated with a signaling based application layer measurement that is unavailable.

In some embodiments, the network device 120 may transmit an indication indicating whether alignment between a logged minimization of drive tests measurement and the application layer measurement is supported. In some embodiments, the network device 120 may transmit information of a measurement configuration for which a start or stop of a session triggers a start or stop of the logged minimization of drive tests measurement. In some embodiments, the network device 120 may transmit a trace reference of the logged minimization of drive tests measurement for which the alignment is applied.

It is to be understood that the operations of methods 300 and 400 are similar as that described in connection with FIG. 2, and thus other details are not repeated here for concise.

### Example Implementation of Devices and Apparatuses

FIG. 5 is a simplified block diagram of a device 500 that is suitable for implementing embodiments of the present disclosure. The device 500 can be considered as a further example implementation of the terminal device 110 or the network device 120 as shown in FIG. 1. Accordingly, the device 500 can be implemented at or as at least a part of the terminal device 110 or the network device 120.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 510 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 530 is assumed to include program instructions that, when executed by the associated processor 510, enable the device 500 to operate in accordance with the embodiments of the present disclosure, as discussed herein with reference to FIGS. 1 to 4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

In some embodiments, a terminal device comprises a circuitry configured to: receive, in a connected state, a configuration regarding an application layer measurement, the configuration comprising at least one of a set of measurement configurations, a set of values of timers or a set of validity areas; and in accordance with a determination that the terminal device enters an idle or inactive state, perform the application layer measurement based on the configuration.

In some embodiments, a network device comprises a circuitry configured to: transmit a configuration regarding an application layer measurement, the configuration comprising at least one of a set of measurement configurations, a set of values of timers or a set of validity areas.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a method of communication comprises: receiving, at a terminal device in a connected state, a configuration regarding an application layer measurement, the configuration comprising at least one of a set of measurement configurations, a set of values of timers or a set of validity areas; and in accordance with a determination that the terminal device enters an idle or inactive state, performing the application layer measurement based on the configuration.

In some embodiments, a measurement configuration in the set of measurement configurations comprises at least one of the following: an identity of the measurement configuration; a container of the application layer measurement for an application layer; a service type indicating a subset of services in the connected state; a measurement configuration of a radio access network visible application layer measurement; an indication indicating whether the terminal device transmits a notification when a session in the application layer starts and stops; an indication indicating whether the measurement configuration is used for the terminal device in the idle or inactive state; or an indication indicating whether the measurement configuration is used for a signaling based application layer measurement or a management based application layer measurement.

In some embodiments, the set of values of timers comprises at least one of the following: a value of a timer for a measurement configuration used for a signaling based application layer measurement; a value of a timer for a measurement configuration used for a management based application layer measurement; a value of a timer for a measurement configuration used for a radio access network visible application layer measurement; a value of a timer for the set of measurement configurations; or a value of a timer for a configuration in the set of measurement configurations.

In some embodiments, the set of validity areas comprises at least one of the following: a validity area for a measurement configuration used for a signaling based application layer measurement; a validity area for a measurement configuration used for a management based application layer measurement; a validity area for a measurement configuration used for a radio access network visible application layer measurement; a validity area for the set of measurement configurations; or a validity area for a configuration in the set of measurement configurations.

In some embodiments, the set of validity areas comprises at least one of the following: a set of cell identities; a set of tracking area codes; a set of tracking area identities; a set of radio access network notification areas; or a set of frequencies.

In some embodiments, the method above further comprises: in accordance with a determination that the configuration regarding the application layer measurement is received, performing at least one of the following: informing upper layers of the terminal device to release at least a portion of a further configuration regarding a further application layer measurement; discarding at least a portion of reports regarding the further application layer measurement; forwarding, to the upper layers, a first configuration regarding an application layer measurement in idle and inactive states; starting or restarting a timer; starting or restarting a timer upon entering the idle or inactive state; indicating the upper layers to suspend or deactivate or stop the application layer measurement; or indicating the upper layers to resume or activate or start the application layer measurement upon entering the idle or inactive state.

In some embodiments, the configuration regarding the application layer measurement comprises a first configuration regarding an application layer measurement in idle and inactive states, and wherein the method further comprises: in accordance with a determination that the first configuration is received, performing at least one of the following: discarding at least a portion of a second configuration regarding an application layer measurement in idle and inactive states; discarding at least a portion of reports regarding an application layer measurement based on the second configuration; storing parameters comprised in the first configuration; starting or restarting a timer; starting or restarting a timer upon entering the idle or inactive state; or forwarding the first configuration to the upper layers upon entering an idle or inactive state.

In some embodiments, the method above further comprises: in accordance with a determination that the configuration regarding the application layer measurement is received, performing at least one of the following: informing upper layers of the terminal device to release at least a portion of a further configuration regarding a further application layer measurement; discarding at least a portion of reports regarding the further application layer measurement; forwarding, to the upper layers, the configuration regarding the application layer measurement; starting or restarting a timer; starting or restarting a timer upon entering the idle or inactive state; or in accordance with a determination that a measurement configuration in the set of measurement configurations is indicated to be not applied for the idle or inactive state, releasing the measurement configuration upon entering the idle state or storing the measurement configuration upon entering the inactive state.

In some embodiments, the method above further comprises: in accordance with a determination that the timer expires, performing a first operation; or in accordance with a determination that a memory reserved for the application layer measurement becomes full, stopping the timer and performing the first operation, the first operation comprising at least one of the following: discarding the configuration regarding the application layer measurement; discarding a measurement configuration of a radio access network visible application layer measurement in the configuration regarding the application layer measurement; informing the upper layers to release the configuration regarding the application layer measurement or suspend the application layer measurement; informing the upper layers to release the measurement configuration of the radio access network visible application layer measurement or suspend the radio access network visible application layer measurement; discarding a report of the application layer measurement after a first period of time since the timer expires; or discarding a report of the radio access network visible application layer measurement after a second period of time since the timer expires.

In some embodiments, the method above further comprises: in accordance with a determination that the terminal device moves from a first cell that belongs to a validity area in the set of validity areas to a second cell that does not belong to the validity area, performing at least one of the following: informing upper layers of the terminal device to release the configuration regarding the application layer measurement or suspend the application layer measurement; informing upper layers of the terminal device to release a measurement configuration of a radio access network visible application layer measurement in the configuration regarding the application layer measurement or suspend the radio access network visible application layer measurement; discarding the configuration regarding the application layer measurement; or discarding the measurement configuration of the radio access network visible application layer measurement.

In some embodiments, the method above further comprises: in accordance with a determination that the terminal device moves from a second cell that does not belong to a validity area in the set of validity areas to a first cell that belongs to the validity area, performing at least one of the following: informing upper layers of the terminal device to resume or activate or start the application layer measurement; informing the upper layers to resume or activate or start a radio access network visible application layer measurement; forwarding, to the upper layers, the configuration regarding the application layer measurement; or forwarding, to the upper layers, a measurement configuration of a radio access network visible application layer measurement in the configuration regarding the application layer measurement.

In some embodiments, the method above further comprises at least one of the following: storing a report of the application layer measurement; transmitting a report of the application layer measurement, the report comprising a list of identities or a bitmap indicating that at least one measurement configuration has available measurement results; or based on reception of a list of identities or a bitmap indicating that measurement results associated with at least one measurement configuration is to be reported, reporting the measurement results associated with the at least one measurement configuration.

In some embodiments, the method above further comprises at least one of the following: initiating a radio resource control setup procedure or a radio resource control resume procedure for transmission of a report of the application layer measurement; or transmitting a report of the application layer measurement in a radio resource control message.

In some embodiments, transmitting the report of the application layer measurement comprises: transmitting the report of the application layer measurement via a small data transmission. In some embodiments, transmitting the report of the application layer measurement via the small data transmission comprises: transmitting, via a signaling radio bearer, a radio resource control message carrying the report of the application layer measurement, the signaling radio bearer comprising at least one of the following: a signaling radio bearer 2; a signaling radio bearer 1 configured for the small data transmission; a signaling radio bearer 4 configured for the small data transmission; or a signaling radio bearer dedicated for the small data transmission.

In some embodiments, transmitting the report of the application layer measurement comprises: transmitting, in the radio resource control message, an indication indicating availability of the report of the application layer measurement; receiving a request for obtaining the report of the application layer measurement; and transmitting the report of the application layer measurement.

In some embodiments, the report comprises at least one of the following: an identity of a measurement configuration of the application layer measurement; a container of the application layer measurement for upper layers; an indication indicating whether a session is started or stopped; measurement results of a radio access network visible application layer measurement; information of a time stamp of the report; or information of an area at which the report is received by a lower layer from upper layers of the terminal device.

In some embodiments, the measurement results of the radio access network visible application layer measurement comprises at least one of the following: an application layer buffer level; an initial playout delay; a list of identities of protocol data unit sessions; or information of a multicast broadcast service session.

In some embodiments, information of the area comprises at least one of the following: an identity of a cell; an identity of a tracking area; a tracking area code; an identity of a radio access network notification area; or a frequency.

In some embodiments, the method above further comprises: in accordance with a

determination that the terminal device changes from the idle or inactive state to the connected state, informing upper layers of the terminal device to release the configuration regarding the application layer measurement or suspend the application layer measurement.

In some embodiments, a measurement configuration in the set of measurement configurations comprises an indication indicating whether the measurement configuration is used for a signaling based application layer measurement. In these embodiments, the method above further comprises: in accordance with a determination that the timer is running, transmitting a radio resource control message comprising an indication indicating that the signaling based application layer measurement is available; or in accordance with a determination that the timer is not running and measurement results of the application layer measurement is to be reported, transmitting a radio resource control message comprising an indication indicating that the signaling based application layer measurement is unavailable.

In some embodiments, a measurement configuration in the set of measurement configurations comprises an indication indicating whether the measurement configuration is used for a signaling based application layer measurement. In these embodiments, the method above further comprises: in accordance with a determination that the timer is running, transmitting a radio resource control message comprising information of a measurement configuration associated with a signaling based application layer measurement that is available; in accordance with a determination that the timer is not running and measurement results of the application layer measurement is to be reported, transmitting a radio resource control message comprising information of a measurement configuration associated with a signaling based application layer measurement that is unavailable; or based on reception of the configuration regarding the application layer measurement, releasing a measurement configuration having a same identity as a measurement configuration in the configuration or releasing a management based application layer measurement.

In some embodiments, the method above further comprises at least one of the following: receiving an indication indicating whether alignment between a logged minimization of drive tests measurement and the application layer measurement is supported; receiving information of a measurement configuration for which a start or stop of a session triggers a start or stop of the logged minimization of drive tests measurement; or receiving a trace reference of the logged minimization of drive tests measurement for which the alignment is applied.

In some embodiments, the method above further comprises: in accordance with a determination that a session starts, starting performing the logged minimization of drive tests measurement in a time interval; or in accordance with a determination that a session stops, stopping performing the logged minimization of drive tests measurement.

In another solution, a method of communication comprises: transmitting, at a network device, a configuration regarding an application layer measurement, the configuration comprising at least one of a set of measurement configurations, a set of values of timers or a set of validity areas.

In some embodiments, a measurement configuration in the set of measurement configurations comprises at least one of the following: an identity of the measurement configuration; a container of the application layer measurement for an application layer; a service type indicating a subset of services in the connected state; a measurement configuration of a radio access network visible application layer measurement; an indication indicating whether the terminal device transmits a notification when a session in the application layer starts and stops; an indication indicating whether the measurement configuration is used for a terminal device in an idle or inactive state; or an indication indicating whether the measurement configuration is used for a signaling based application layer measurement or a management based application layer measurement.

In some embodiments, the set of values of timers comprises at least one of the following: a value of a timer for a measurement configuration used for a signaling based application layer measurement; a value of a timer for a measurement configuration used for a management based application layer measurement; a value of a timer for a measurement configuration used for a radio access network visible application layer measurement; a value of a timer for the set of measurement configurations; or a value of a timer for a configuration in the set of measurement configurations.

In some embodiments, the set of validity areas comprises at least one of the following: a validity area for a measurement configuration used for a signaling based application layer measurement; a validity area for a measurement configuration used for a management based application layer measurement; a validity area for a measurement configuration used for a radio access network visible application layer measurement; a validity area for the set of measurement configurations; or a validity area for a configuration in the set of measurement configurations.

In some embodiments, the set of validity areas comprises at least one of the following: a set of cell identities; a set of tracking area codes; a set of tracking area identities; a set of radio access network notification areas; or a set of frequencies.

In some embodiments, the method above further comprises at least one of the following: receiving a report of the application layer measurement, the report comprising a list of identities or a bitmap indicating that at least one measurement configuration has available measurement results; or transmitting a list of identities or a bitmap indicating that measurement results associated with at least one measurement configuration is to be reported.

In some embodiments, the method above further comprises at least one of the following: performing a radio resource control setup procedure or a radio resource control resume procedure for reception of a report of the application layer measurement; or receiving a report of the application layer measurement in a radio resource control message.

In some embodiments, receiving the report of the application layer measurement comprises: receiving the report of the application layer measurement via a small data transmission.

In some embodiments, receiving the report of the application layer measurement via the small data transmission comprises: receiving, via a signaling radio bearer, a radio resource control message carrying the report of the application layer measurement, the signaling radio bearer comprising at least one of the following: a signaling radio bearer 2; a signaling radio bearer 1 configured for the small data transmission; a signaling radio bearer 4 configured for the small data transmission; or a signaling radio bearer dedicated for the small data transmission.

In some embodiments, the method above further comprises at least one of the following: configuring a signaling radio bearer 1 for the small data transmission; configuring a signaling radio bearer 4 for the small data transmission; or configuring a signaling radio bearer dedicated for the small data transmission.

In some embodiments, receiving the report of the application layer measurement comprises: receiving, in the radio resource control message, an indication indicating availability of the report of the application layer measurement; transmitting a request for obtaining the report of the application layer measurement; and receiving the report of the application layer measurement.

In some embodiments, the report comprises at least one of the following: an identity of a measurement configuration of the application layer measurement; a container of the application layer measurement for upper layers; an indication indicating whether a session is started or stopped; measurement results of a radio access network visible application layer measurement; information of a time stamp of the report; or information of an area at which the report is received by a lower layer from upper layers of the terminal device.

In some embodiments, the information of the time stamp of the report comprises at least one of the following: an application layer buffer level; an initial playout delay; a list of identities of protocol data unit sessions; or information of a multicast broadcast service session.

In some embodiments, the information of the area comprises at least one of the following: an identity of a cell; an identity of a tracking area; a tracking area code; an identity of a radio access network notification area; or a frequency.

In some embodiments, the method above further comprises: receiving a radio resource control message comprising an indication indicating that the signaling based application layer measurement is available; or receiving a radio resource control message comprising an indication indicating that the signaling based application layer measurement is unavailable.

In some embodiments, the method above further comprises: receiving a radio resource control message comprising information of a measurement configuration associated with a signaling based application layer measurement that is available; or receiving a radio resource control message comprising information of a measurement configuration associated with a signaling based application layer measurement that is unavailable.

the method above further comprises at least one of the following: transmitting an indication indicating whether alignment between a logged minimization of drive tests measurement and the application layer measurement is supported; transmitting information of a measurement configuration for which a start or stop of a session triggers a start or stop of the logged minimization of drive tests measurement; or transmitting a trace reference of the logged minimization of drive tests measurement for which the alignment is applied.

In another solution, a device of communication comprises: a processor configured to cause the device to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 4. Generally. program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-20. (canceled)

21. A method of communication for a User Equipment (UE), the method comprising:
receiving, from a network device, a Radio Resource Control (RRC) reconfiguration message including first configuration information of an application layer measurement for a Quality of Experience (QoE) measurement, wherein the first configuration information comprises second configuration information regarding the application layer measurement applicable to idle and inactive states; and
sending, to the network device, a report of the application layer measurement.

22. The method of claim 21, wherein the first configuration information further comprises an identity of the application layer measurement.

23. The method of claim 21, wherein the first configuration information further comprises a service type.

24. The method of claim 21, wherein the first configuration information further comprises an indication indicating whether the UE sends a notification when a session in the application layer starts and stops.

25. The method of claim 21, wherein the second configuration information comprises an indication indicating whether the application layer measurement is used for a signaling based application layer measurement or a management based application layer measurement.

26. The method of claim 21, further comprising:
releasing a configuration for the application layer measurement upon going to the idle state in case of the configuration without the second configuration information.

27. The method of claim 21, further comprising:
discarding at least a portion of reports regarding an application layer measurement.

28. A method of communication for a network device, the method comprising:
sending, to a User Equipment (UE), a Radio Resource Control (RRC) reconfiguration message including first configuration information of an application layer measurement for a Quality of Experience (QoE) measurement, wherein the first configuration information comprises second configuration information regarding the application layer measurement applicable to idle and inactive states.

29. The method of claim 28, wherein the first configuration information further comprises an identity of the application layer measurement.

30. The method of claim 28, wherein the first configuration information further comprises a service type.

31. The method of claim 28, wherein the first configuration information further comprises an indication indicating whether the UE sends a notification when a session in the application layer starts and stops.

32. The method of claim 28, wherein the second configuration information comprises an indication indicating whether the application layer measurement is used for a signaling based application layer measurement or a management based application layer measurement.

33. A User Equipment (UE) comprising:
a memory storing instructions; and
a processor configured to execute the instructions to:
receive, from a network device, a Radio Resource Control (RRC) reconfiguration message including first configuration information of an application layer measurement for a Quality of Experience (QoE) measurement, wherein the first configuration information comprises second configuration information regarding the application layer measurement applicable to idle and inactive states, and
send, to the network device, a report of the application layer measurement.
